(19) United States
(12) Patent Application Publication
(10) Pub. No.: US 2010/0213264 A1
(43) Pub. Date: Aug. 26, 2010

(54) METHOD FOR RFID TAGGING

(75) Inventors: Heikki Ahokas, Tampere (FI); Matti Ritamäki, Nokia (FI); Marko Hanhikorpi, Pirkkala (FI)

Correspondence Address: HOLLAND & KNIGHT LLP, 2099 PENNSYLVANIA AVE, SUITE 100, WASHINGTON, DC, 20006, US

(73) Assignee: CONFIDEX OY, Tampere (FI)

(21) Appl. No.: 12/682,446

(22) PCT Filed: Oct. 15, 2008
(86) PCT No.: PCT/FI08/50575

§ 371 Date: May 11, 2010

Related U.S. Application Data
(60) Provisional application No. 60/960,838, filed on Oct. 16, 2007.

(51) Int. Cl. G06K 19/077; H01P 11/00

(52) U.S. Cl. 235/492; 29/600

(57) ABSTRACT

An RFID tag to be attached to an item, and a method. The tag comprises an antenna and an integrated circuit. The RFID tag further comprises a substrate on which the antenna is attached. The substrate is construed to form a stand-off relation between the item and the antenna when buried inside of the material of the item.

### FIELD OF THE INVENTION

The present invention relates to an RFID tag to be attached to an item, the tag comprising an antenna and an integrated circuit, the RFID tag further comprising a substrate on which the antenna is attached.

The present invention further relates to a method for marking an item.

### BACKGROUND OF THE INVENTION

RFID (Radio Frequency Identification) tagging of items made of materials which can be either wet or dry during their lifetime (for example, on concrete walls/floors, logs, wooden pallets, etc.) is very problematic. This is because dielectric properties are very different in dry and wet materials. For wet conditions, the RF (Radio Frequency) design and tuning of the tag have to be very different compared to dry conditions. In practice, this means that in order to enable RFID tag functionality, two tags have to be used: one designed for wet conditions, another for dry conditions. As an example, a wooden pallet application can be presented. Solving the RFID tagging problem in wooden pallets has been a great challenge for a long time. Both the mechanical durability of the tag and the fact that wood is RF-wise very different in its wet and dry stages have caused serious implementation problems.

Mechanical durability issues in the case of a wooden pallet are related to the survivability of the tag when wooden pallet is handled. Since wood has very different RF and dielectric properties (dielectric constant, loss factor) when it is dry and wet, the attachment of the RFID tag to the surface of the wood pallet with some stand-off from wood has been preferred. The term “stand-off” means spacing the antenna of the tag off of the surface of the item.

Normally, the RFID tag is located either one of the center/corner blocks or one of the top/side boards. However, when the tag is attached to the outer surface of the wooden pallet, it never survives a long time, since forklifts push and handle pallets in such a way that will break the tag. Even if the tag cover is made of steel or plastic, or if the tag is thin and flexibly laminated, it is always broken when a forklift with a huge mass hits the tag.

When a very thin tag structure has been used and the attachment has been selected so that the tag is on the surface of wood without any standoff, this has created RF functionality problems since, as mentioned above, the RF performance of the tag is dramatically affected by the fact whether the wood is dry or wet. The tag can only be optimized for either wet or dry wood conditions but not for both at the same time.

Not only wooden pallets but also tagging or marking of log of woods, food casings and other consumer packing as well as in woodworks and ornamental structures made of wood, for instance, have been problematic with known RFID tags.

### BRIEF DESCRIPTION OF THE INVENTION

An object of the present invention is thus to provide an RFID tag and a method for marking items so as to alleviate the above disadvantage.

The identification tag of the invention is characterized in that the substrate is construed to form a stand-off relation between the item and the antenna when buried inside of the material of the item.

The method of the invention is characterized by making a space in the item for positioning an RFID tag to said item, said RFID tag comprising an antenna and an integrated circuit, the RFID tag further comprising a substrate, inserting the RFID tag in said space in the item, and attaching the RFID tag in said space in the item so that the antenna does not touch the surface of the item.

The invention is based on the realization that the RFID tag may be buried inside the item, such as a wood block, but in such a way that it does not touch the surface of the item. An advantage is that the RFID tag is always under the same dielectric constant load conditions, and its RF performance remains the same all the time.

### BRIEF DESCRIPTION OF THE DRAWINGS

In the following the invention will be described in greater detail by means of preferred embodiments with reference to the attached [accompanying] drawings, in which

FIG. 1 is a schematic view of a step of an embodiment of the method according to the invention;

FIG. 2 is a schematic side view of further steps of the method shown in FIG. 1;

FIG. 3 is a schematic side view of steps of a third embodiment of the method according to the invention;

FIG. 4a is a schematic side view of an identification tag of the invention;

FIG. 4b is a schematic side view of the tag shown in FIG. 4a cut along line A-A; and

FIG. 5 is a schematic view of a fourth embodiment of the method according to the invention.

For the sake of clarity, the figures show the invention in a simplified manner. Like reference numerals identify like elements.

### DETAILED DESCRIPTION OF THE INVENTION

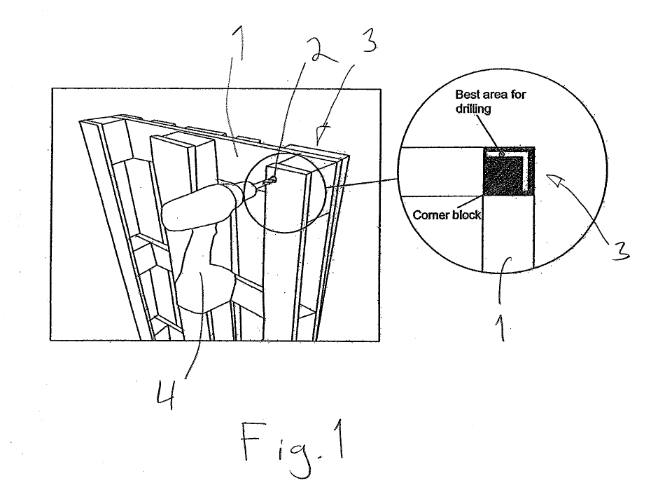

FIG. 1 is a schematic view of a step of an embodiment of the method according to the invention. An item to be tagged is a wooden pallet 1. A hole 2 (the depth of the hole at least equal to the length of the tag) is made in a corner block 3 of the pallet 1 with a drilling machine 4. The bottom side of the corner block 3 is preferred, because it prevents dust from entering the hole 2. The hole 2 is drilled close to the outer sides of the corner block 3 to obtain an optimal reading range for the tag.

In the method according to the invention, the RFID tag is buried inside the material, into a drilled hole (or, for example, a groove), and the shape of the tag is such that it does not touch the surface of the material. In this way it is ensured that the tag does not touch the surface of the material and that the surrounding dielectric constant remains the same, irrespective of the material being wet or dry.

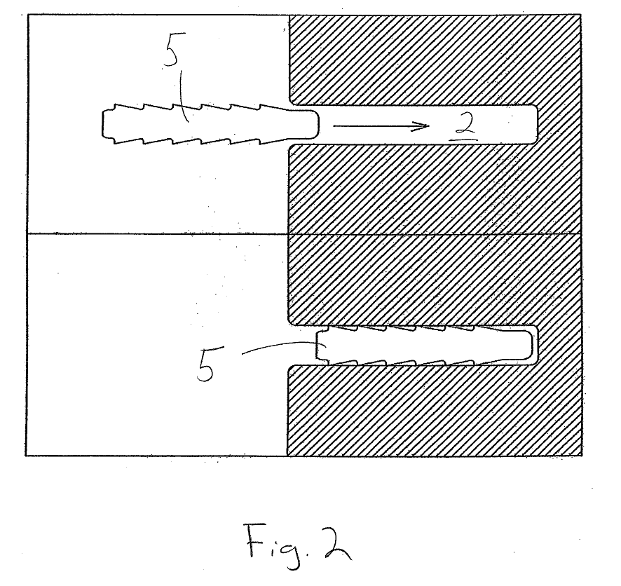

FIG. 2 is a schematic side view of another steps of the method shown in FIG. 1. The tag 5 is just slid into the hole 2. The tag 5 has a sawtooth shape on its longer edges and, thus, it sticks inside the hole 2.

When the tag 5 is inside the item, the wood is also usually dry there. Therefore, the tag 5 is always under the same dielectric constant load conditions, and its RF performance remains the same all the time.

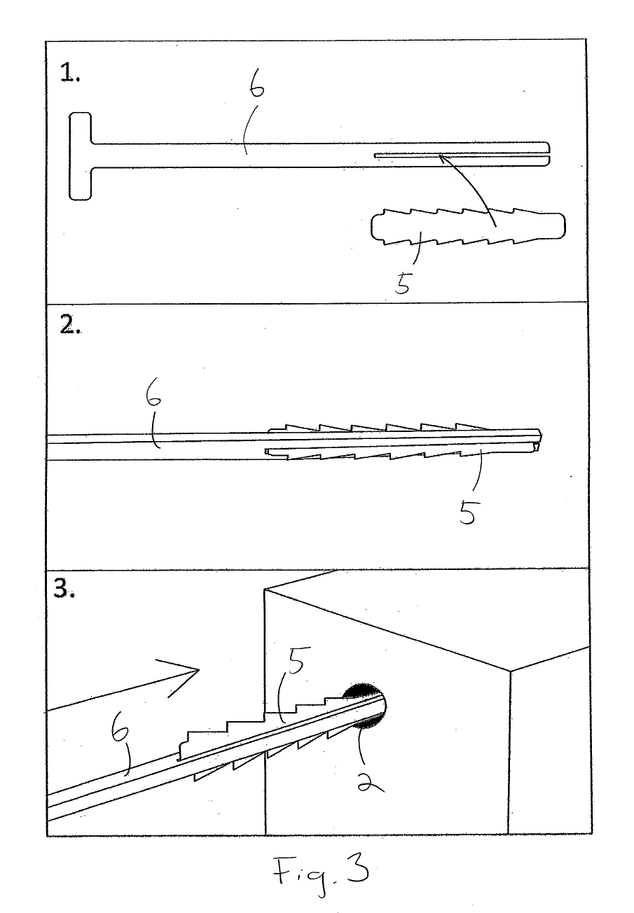

FIG. 3 is a schematic side view of steps of a third embodiment of the method according to the invention. An insertion tool 6 may be used for sliding the tag 5 into a drilled hole 2. The insertion tool 6 may have a longitudinally arranged slit where the tag 5 is kept by an interference fit.

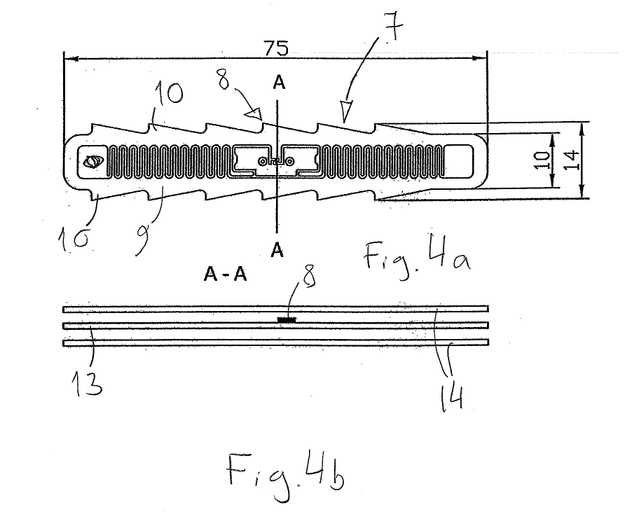

FIG. 4a is a schematic side view of an identification tag of the invention. The dimensions shown in FIG. 4 are just examples of dimensions of an embodiment of a tag according to the invention. The RFID tag 5 may be used for identification of, for instance, wooden pallets.

FIG. 4b is a schematic side view of the tag shown in FIG. 4a cut along line A-A. An antenna layer 13 is arranged between two layers 14 of plastics. The plastics layers are attached to the antenna layer 13 by adhesive layers. The plastic material may be, for instance, PET (Polyethyleneterephthalate) or PP (Polypropylene).

The RFID tag comprises an antenna 7 and an integrated circuit 8 on a chip on a surface of a substrate 9. The RFID tag is relatively rigid due to the plastic layers so that when bending it its structure does not collapse but resists tension exerted on it. The substrate 9 may have, preferably, an elongated form. The long sides of the substrate 9 are serrated. The shape of the teeth 10 of the serrated structure may vary. Further, the teeth 10 of the serrated structure may be inclined so that the tag 5 is easier to push into a mounting hole. It is to be noted that the serration is not an essential feature of the tag but just an optional one.

The substrate 9 has two width dimensions. The first width dimension is the width without the serrated structure, and the second dimension is the width with the serrated structure. In other words, the first width dimension is smaller than the second width dimension by two times the height of the tooth 10. The diameter of the hole or the groove into which the tag 5 is to be inserted is usually chosen so that it is larger than the first dimension of the substrate 9 but smaller than the second dimension of the substrate 9.

The antenna 7 may be a coil or an antenna based on the dipole-antenna technique. The antenna may be manufactured, for example, by printing, etching, die-cutting, vaporizing, sputtering or by some other additive technique on the surface of the substrate. The antenna 7 comprises an electrically conductive material, such as copper, aluminum, or silver.

The substrate 9 is typically a plastic material, such as polyester or PET. It may also be manufactured from some other material, such as cellophane or paper. The substrate 9 may be covered with at least one material layer on at least one side of the substrate 9. The possible material layers are attached to the substrate 9 and each other preferably by laminating. The manufacturing method is preferably continuous, i.e. it uses materials in a web form.

The chip can be a silicon chip or a polymer chip. There are several possibilities to attach the chip to the antenna 7, for example by using solder paste, isotropically conductive adhesive, or anisotropically conductive adhesive. The adhesive can be a film or a fluid adhesive which will be dried and/or cured. The aim is that an electrical connection is formed between the antenna 7 and the chip.

The antenna 7 may be adapted to work at UHF (Ultra-High Frequency) frequencies, preferably at a frequency between 840 MHz and 960 MHz. Another preferable frequency range lays around 13.56 MHz and 2.4 GHz.

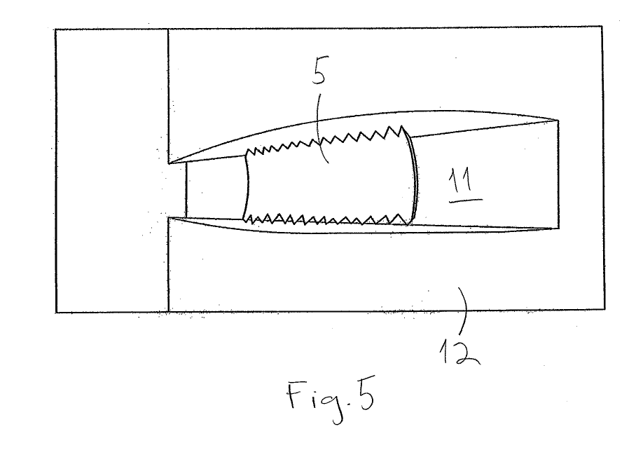

FIG. 5 is a schematic view of a fourth embodiment of the method according to the invention. In this case a log 12 of wood has been tagged. Instead of drilling a hole, a groove 11 is made on the surface of the log 12. Due to the shape and rigidity of the substrate 9, a stand-off to the tag is created. Therefore, the tag 5 works in the same way, irrespective of the moisture content of the wood.

The shape, the material combination and the thickness of the tag can vary, as long as the tag is sufficiently rigid and, preferably, includes some tooth shape in the edges to lock the tag in a hole 2 or groove 11 without touching the surface of the intermediate material of the item that would change the RF tuning of the tag.

It is preferred that the tag of the invention has a flat structure, or a sheet-like structure, i.e. it can be manufactured by laminating. This kind of tag can be manufactured by low-cost methods as a thin laminated version without stand-off or encapsulation material.

Naturally, the tag may also have other shapes. For example, the tag may be a cylinder which fits in a hole. Further, the surface of the cylinder may be threaded.

A skilled person knows the antennas and the antenna substrates well, so more detailed description is not needed here.

It will be obvious to a person skilled in the art that, as the technology advances, the inventive concept can be implemented in various ways. The invention and its embodiments are not limited to the examples described above but may vary within the scope of the claims.

1-10. (canceled)

11. An RFID tag to be attached to an item, the tag comprising an antenna and an integrated circuit, the RFID tag further comprising a substrate on which the antenna is attached, the substrate being construed to form a stand-off relation between the item and the antenna when buried inside of the material of the item.

12. The tag according to claim 11, wherein the tag comprises a relatively rigid and elongated form, and that the long sides of the substrate are serrated.

13. The tag according to claim 11, wherein the tag includes a flat structure.

14. The tag according to claim 11, wherein the tag includes a cylinder structure.

15. The tag according to claim 14, wherein the surface of the cylinder includes threading.

16. The tag according to claim 11, wherein the substrate includes made of polyester or PET.

17. A method for marking an item, the method comprising:
making a space in the item for positioning an RFID tag to said item,
said RFID tag comprising an antenna and an integrated circuit, the RFID tag further comprising a substrate,
inserting the RFID tag in said space in the item, and
attaching the RFID tag in said space in the item so that the antenna does not touch the surface of the item.

18. The method according to claim 17, wherein the space comprises at least one of:
a hole or a groove.

19. The method according to claim 17, wherein the substrate comprises a relatively rigid and elongated form, and that the long sides of the substrate comprises a serrated structure, wherein the tag is attached in the hole or a groove the diameter of which is larger than the width of the substrate without the serrated structures but smaller than the substrate with said serrated structures.

20. The method according to claim 17, whereby making the space includes using wood.

21. The tag according to claim 12, wherein the tag includes a flat structure.

22. The tag according to claim 12, wherein the tag includes a cylinder structure.

23. The method according to claim 18, wherein the substrate comprises a relatively rigid and elongated form, and that the long sides of the substrate comprises a serrated structure, wherein the tag is attached in the hole or a groove the diameter of which is larger than the width of the substrate without the serrated structures but smaller than the substrate with said serrated structures.
